(19) United States
(12) Patent Application Publication
(10) Pub. No.: US 2026/0079982 A1
(43) Pub. Date: Mar. 19, 2026

(54) SEMANTIC SEARCH FOR PROMPT BUILDER SYSTEM

(71) Applicant: Salesforce, Inc., San Francisco, CA (US)

(72) Inventors: Minhaj KHAN, New York, NY (US); Avanthika RAMESH, San Francisco, CA (US); Karen YIN, San Jose, CA (US); Jan Adriaan KRUGER, Fuquay-Varina, NC (US); Reinier H. van LEUKEN, Utrecht (NL)

(73) Assignee: Salesforce, Inc., San Francisco, CA (US)

(21) Appl. No.: 18/988,579

(22) Filed: Dec. 19, 2024

Related U.S. Application Data
(60) Provisional application No. 63/695,110, filed on Sep. 16, 2024.

(51) Int. Cl. G06F 16/334; G06F 16/31; G06F 16/38

(52) U.S. Cl. CPC G06F 16/3347; G06N 20/00

(57) ABSTRACT

Disclosed herein are system, method, and computer program product aspects for semantic search in a model-based prompt builder system. A system generates a search retriever object based on a search index comprising unstructured data. The search retriever object includes metadata specifying one or more details of a vector search operation to be performed on the search index. The system obtains search results by performing the vector search on the search index based on the one or more details of the vector search operation provided by the search retriever object and a search query. The system provides the search results to a prompt generator configured to use a model to generate a reply to a prompt request requiring the search results.

### CROSS-REFERENCE TO RELATED APPLICATIONS

This application claims benefit of U.S. Provisional Application No. 63/695,110, filed Sep. 16, 2024 entitled “SEMANTIC SEARCH FOR PROMPT BUILDER SYSTEM,” the entire disclosure of which is incorporated herein by reference.

### BACKGROUND

Machine Learning (ML) models such as Large Language Models (LLMs) are increasingly capable of comprehending and generating human language text and other generative outputs based on a large data training set. These models are starting to become integrated into a wide variety of fields, such as research, agent response, healthcare, translation, content creation, and a wide array of business applications.

In order to cause a model to produce responsive action, it is often necessary to write a prompt to the model. This prompt is essentially an instruction to the model. The model can digest the prompt instruction(s), resolve one or more data sources based on the instruction(s), and generate a response to the prompt instruction in the form of human language text or other generative output. These data sources are often stored in structured data formats that are digestible by the model.

One or more aspects of the present disclosure relate to the field of ML models, and more specifically to a providing a method of semantic search that produces search results that are easily digestible by ML models. Aspects of the present disclosure provide a method of performing a semantic search on structured and unstructured data and incorporating the search results into a prompt that is then resolved by an ML model.

### BRIEF DESCRIPTION OF THE DRAWINGS

The accompanying drawings are incorporated herein and form a part of the specification.

FIG. 1 illustrates a block diagram of an exemplary search retrieval environment, according to aspects of the present disclosure.

FIG. 2 illustrates a block diagram of an exemplary search retrieval system for use in the search retrieval environment according to aspects of the present disclosure.

FIG. 3 illustrates a flowchart diagram of an exemplary method for search retrieval according to aspects of the present disclosure.

FIG. 4 illustrates a process flow diagram of an exemplary search retrieval process according to aspects of the present disclosure.

FIG. 5 illustrates a block diagram of an exemplary computer system according to aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for semantic search retrieval for a model-based prompt builder system.

Increasingly, there is a need to include unstructured data, such as knowledge articles, chat transcripts, emails, contracts, and other context-intensive documents, in the data that can be digested by a model. Traditional keyword searching is ineffective in these cases because the results lack context and are often irrelevant. Instead, there is a need for semantic searching, which is capable of producing context-dependent results from unstructured data. However, the results of semantic searches are often incompatible with the algorithms employed by, and thus are incompatible with, ML models.

Many different business computer environments, and in particular those that serve customer or subscriber needs, may include one or more ML models, LLM models, etc. (collectively, “model” or “models”) that can be used by customers to carry out various tasks. For example, a customer sales environment may be used by subscribers to track sales team statistics, as well as account information of their customers. Such account information may include information relating to a sales individual or sales team, including volume or dollars sold, number of accounts being handled, and customer business and contact information, and sales targets. Meanwhile, the account information may further include information relating to the different accounts, such as customer business information, primary contacts, pending accounts, account targets etc. In such an environment, ML models may be made available to the subscribers in order to assist them with their various business tasks. In aspects, such tasks may include a wide range of requests, from something as fundamental as making a request for information (e.g., “what is the contact information of the primary point of contact at Company A?”) to something far more complex (e.g., “For all accounts currently assigned to Salesperson A, generate a spreadsheet showing percentages of sales to those accounts over the various products purchased by those accounts. ”).

Notably, while there has been significant movement in the business industry toward the use of models in their day-to-day operations, these models are often constrained by their reliance on structured data from highly curated data stores. Developing and maintaining these curated data stores is a time-intensive task that requires direct input of data in formats that are accessible by the model(s). For example, details of service contracts may have to be manually entered into a spreadsheet. However, there is a large amount of data generated by businesses that is unstructured. This unstructured data can include volumes of emails, text chats, contracts and agreements, and knowledge articles. This unstructured data, if delivered in a format usable by a model, can provide valuable grounding for the model in understanding the instructions in a prompt, resolving the required data sets, and generating a response to a prompt.

In aspects of the present disclosure, a search retriever module may receive a search index comprising unstructured data and generate a search retriever object based on the search index. In aspects, the search retriever object may include metadata specifying one or more details of a vector search operation to be performed on the search index. In aspects, the search retriever module may obtain search results by performing the vector search on the search index based on the one or more details of the vector search operation provided by the search retriever object and a search query. In aspects, the search retriever module may provide the search results to a prompt generator configured to use a model to generate a reply to a prompt request requiring the search results.

In aspects, the search retriever module may be further integrated into a hosting environment including a prompt generator. In aspects, the prompt generator may be able to determine if the search results are required to generate the reply to the prompt request, to retrieve records or other data from the hosting environment or one or more databases for use in resolving the prompt, to write new data to one or more databases associated with the hosting environment based on the output of a model, and/or able to send a request to the search retriever module requesting the search results.

These and other aspects of the present disclosure will be described in further detail below with respect to the accompanying drawings.

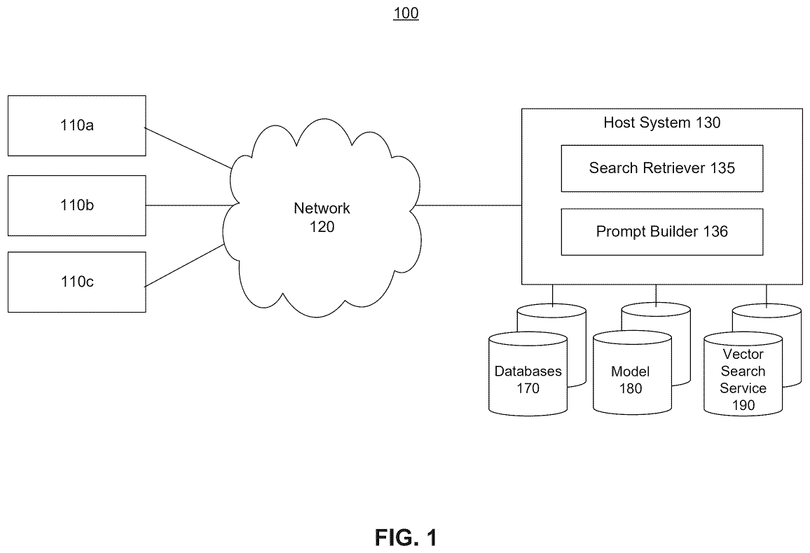

FIG. 1 illustrates a block diagram of an exemplary search retrieval environment 100, according to aspects of the present disclosure. As shown in FIG. 1, the environment 100 includes user devices 110a, 110b, and 110c, which take the form of a mobile device, personal computer, or other electronics device capable of communicating over a network, such as a smartphone, tablet computer, personal digital assistant, smartwatch, etc. The environment 100 also includes a host system 130. In aspects, the host system 130 may include all interfaces and functionality in support of the subscriber, as well as internal systems. According to aspects, host system 130 may include a search retriever module 135 and a prompt generator module 136.

As shown in FIG. 1, the user devices 110a, 110b, and 110c connect to the host system 130 over a network 120. In aspects, network 120 may be any type of computer or telecommunications network capable of communicating data, including but not limited to a local area network, a wide-area network (e.g., the Internet), or any combination thereof. The network may include wired and/or wireless segments. In some aspects, network 120 may be a secure network. In some aspects, one or more of the user devices 110a, 110b, 110c may reside within network 120.

As shown in FIG. 1, host system 130 may have accesses to a plurality of databases or libraries, including one or more databases 170, at least one model 180, and a vector search service (VSS) 190. In aspects, databases 170 may include data relating to the specific company accessing the service, its employees, or business accounts associated with the company or its employees, such as one or more sales accounts. In aspects, model 180 and VSS 190 may be located within host system 130, separate from but still local to host system 130, or may be remote from but by accessible by host system 130. In aspects, model 180 may be a machine learning (ML) model, a large language model (LLM), or other similar model. VSS 190 may, according to aspects, comprise a cloud based vector search engine. For example, VSS 190 may comprise an external vector search engine. However, VSS 190 is not limited to being cloud based and, in some aspects, may be local to host system 130.

According to aspects, a user of user device 110a, 110b, 110c may access search retriever module 135 via network 120. In a user interface (UI) associated with this access, the search retriever module 135 may provide the user with various options for configuring a search retriever object. After configuration, the search retriever object may be stored by search retriever module 135. Search retriever module 135 may obtain search results relating to the search retriever object by performing a vector search on the search index. In some aspects, the vector search may be performed by VSS 190. Search retriever module 135 may store the search results as part of the search retriever object or as a separate data object associated with the search retriever object.

According to aspects, a user of a user device 110a, 110b, 110c may access prompt generator module 136 via network 120. The UI may provide the user with a prompt template for submitting a query to prompt generator module 136. As a non-limiting example, the query may be a task related to the user's business, such as providing sales numbers for a particular customer or drafting an email to a plurality of customers. In aspects, prompt generator module 136 may use this query to generate a prompt. The prompt may comprise one or more instructions that indicate how model 180 should resolve one or more search results and/or one or more data sets. In generating the prompt, prompt generator module 136 may request one or more sets of search results from search retriever module 135 as well as one or more data sets from databases 170. In aspects, the prompt may include instructions indicating how the model should resolve each of the search result(s) and/or data set(s). Prompt generator module 136 may transmit the prompt and any required search results and/or data sets to model 180. Prompt generator module 136 may receive a response to the prompt from model 180 and generate a reply to the query.

These processes will be described in further detail below with respect to the remaining figures.

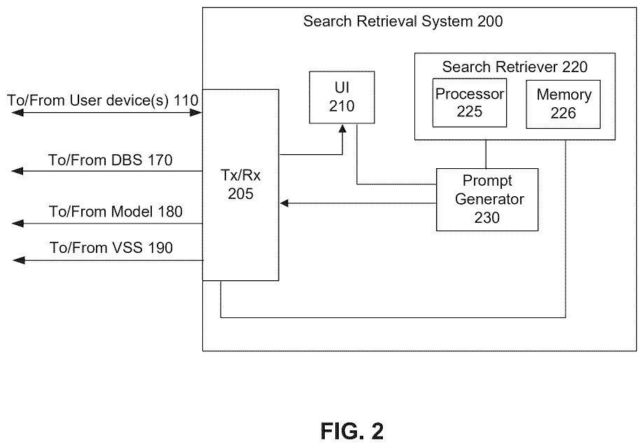

FIG. 2 illustrates a block diagram of an exemplary search retrieval system 200 according to aspects of the present disclosure. As shown in FIG. 2, search retrieval system 200 includes a transceiver 205, at least one UI 210, a search retriever module 220, and a prompt generator module 230. Search retrieval module 220 may include one or more processors 225 and one or more memories 226. In aspects, transceiver 205 may be capable of communicating with local devices 110 as well as over the network 120 using one or more digital communication protocols. In aspects, transceiver 205 may be responsible for communicating with user device(s) 110, with databases 170, with model 180, and/or with VSS 190.

According to aspects, while a user is in communication with the search retrieval system 200, UI 210 provides the primary go-between. In aspects, the user may interact with UI 210 to configure a search retriever by providing one or more search indices and/or data objects to search retriever 220. In some aspects, configuring a search retriever may additionally include providing one or more other configuration settings to search retriever 220. According to aspects, the user may interact with UI 210 to provide one or more search queries and/or one or more prompt requests to prompt generator 230. In some aspects, the user may also provide one or more other configuration settings to prompt generator 230. According to aspects, the user may interact with UI 210 to receive output data from search retriever 220 and/or prompt generator 230.

In some aspects, a user interacts with UI 210 to provide a search index to search retriever module 220. The search index may comprise unstructured data and/or structured data. This is discussed in more detail below.

According to aspects, upon receiving a search index, processor 225 may generate a search retriever object associated with the search index. The search retriever object may be configurable via UI 210 by user device(s) 110, as discussed above. The search retriever object may include metadata specifying one or more details of a search operation to be performed on the search index. In aspects, the search retriever object may specify one or more parameters of a search operation, such as the name, version number, data object, number of results to return, fields to return, confidence and/or similarity scores, filtering, and/or ranking of search results to be returned. In aspects, the search retriever object may specify one or more details of a vector search operation to be performed on the search index. As a non-limiting example, the metadata may indicate that an approximate nearest neighbor (ANN) algorithm should be used to retrieve matches to one or more keywords or concepts. In some aspects, the search retriever object may comprise a retrieval automated generation (RAG) retriever object that instructs a model as to how and when to consider multiple pieces of data. In some aspects, the search retriever object may comprise a persistent metadata object that is stored by the search retriever module 220. In some aspects, search retriever module 220 may store the search retriever object in memory 226, either before or after receiving search results, as explained below.

According to aspects, after receiving a search index and generating a search retriever object, search retriever module 220 may perform a vector search on the search index to obtain search results. In some aspects, search retriever module 220 may perform the vector search based on instructions from, for example, prompt generator 230 and a search query provided by the user. In some aspects, after configuring the search retriever object, search retriever module 220 may immediately perform the vector search and store the search results in memory. In some aspects, the search results may be stored as part of the search retriever object. In some aspects, the search results may be stored as a separate data object that is associated with the search retriever object. In aspects, the search results may comprise one or more vectors corresponding to keywords, concepts, and/or documents that match criteria set forth by the search retriever object and the search query provided by the user. The search results may be obtained by search retriever system 200 performing the vector search or by receiving results of the vector search from VSS 190 via transceiver 205.

According to aspects, a user may interact with UI 210 to provide a prompt request to prompt generator module 230. Prompt generator module 230 may use the prompt request to generate a prompt that is configured, after being resolved, to provide a reply to the query. For example, using UI 210, a user may send a prompt request to prompt generator module 230 instructing prompt generator module 230 to use one or more search results and one or more data sets to generate text usable by the user.

As a non-limiting example, a user may request that prompt generator module 230 use search results of discounts within a customer contract, together with name and address data sets, to generate a sales email that the user can send to customers. In this case, the customer contract may form the unstructured data of a search index, and the vector search operation may perform an operation on the search index looking for all discounts within the customer contract. Upon receiving the user's prompt request, prompt generator module 230 may determine that generating a reply to this prompt request requires using search results. In this case, prompt generator module 230 may request that search retriever 220 execute the vector search based on the search index and the search query, and then return the search results to the prompt generator. In addition, as discussed below, the prompt generator may determine that the name and address data sets should be retrieved from one or more separate data store(s).

In aspects, upon receiving a prompt request, prompt generator module 230 may translate the prompt request into a prompt for model 180. Prompt generator 230 performs any additional processing that may be required for generating the appropriate prompt to the model. For example, generating the prompt may require one or more calls to external data, such as one or more files or records stored in the databases 170. In this example, prompt generator module 230 may retrieve the relevant information from the databases 170 before prompt generation. Similarly, certain customer requests may require “translation” into a more understandable format. This may particularly be true for a natural language request. Such translation may be rules based or may involve one or more machine learning models in order to decipher the “meaning” and/or “intent” of the customer's request.

In aspects, prompt generator module 230 may transmit the prompt and any search results and/or data sets to model 180. Model 180 may process the received prompt, search results, and/or data sets to generate a response to the prompt that is then sent back to prompt generator module 230. When an output is received from model 180, the output may be again provided to prompt generator module 230 for further processing. Prompt generator module 230 may perform different functions depending on the output. For example, for a straightforward output, prompt generator module 230 may simply forward the output as the reply to the user. However, certain other outputs may include new data to be written to the one or more databases 170, in which case prompt generator module 230 will communicate with and update the respective database(s) accordingly before or after output to the user. Likewise, certain other outputs may require “re-translation” to place it in a form that can be readily understood by the user. The resulting output of the model may be provided to the user as a reply transmitted to a user device 110a, 110b, 110c.

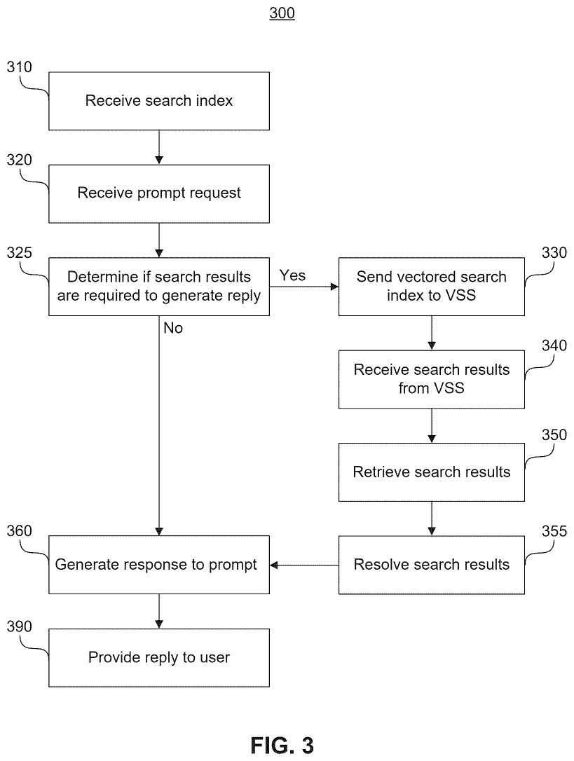

FIG. 3 illustrates a flowchart diagram of an exemplary method 300 for search retrieval according to aspects of the disclosure. As shown in FIG. 3, the method begins at step 310, with a search retrieval system receiving a search index from a user device. In some aspects, the search retrieval system used in the processes of FIG. 3 may resemble, in some ways, search retrieval system 200.

In some aspects, the search index may be retrieved by the user and sent to a search retrieval system. In some aspects, the search index may be built by the user. For example, a user may build a search index from a data repository comprising unstructured and/or structured data. According to aspects, a user may group data in the data repository into one or more data representations. For example, the user may create a data representation by selecting one or more documents from a repository of unstructured documents. The user may then create one or more data objects comprising one or more of the data representations. In aspects, a data object may correspond to one particular document, or may correspond to a group of similar documents, for example, emails or contracts. In some aspects, the data objects may comprise unstructured data that is merely, sorted, categorized, and or collected into data objects.

In aspects, each data object may be chunked according to a chunking algorithm to divide the object into smaller data chunks. The data chunks may then be embedded and/or vectorized to convert the data chunks into vector sets of values. Thus, in aspects, the search index may comprise vectored data chunks In step 320, the search retrieval system may receive a query from a user device 110a, 110b, 110c. The prompt generator module may translate the query into a prompt for the model. The prompt may comprise one or more instructions indicating how the model should resolve the search results and/or data sets. In generating the prompt, the search retrieval system may retrieve one or more data sets from databases 170.

At step 325, the search retrieval system may determine if one or more search results are required to generate a reply to the query. If the search retrieval system determines that search results are required to generate the reply (325—Yes), the search retrieval system may retrieve the required search result(s) by sending a request to the search retriever module with a user-provided search query. For example, the prompt generator module may send a request to the search retriever module instructing the search retriever module to perform the vector search operation. On the other hand, if the search retrieval system determines that search result(s) are not required (325—No), the model generates a response to the prompt at step 360 without retrieving and resolving the search results.

In step 330, the search retrieval system may perform the vector search on the search index and obtains the search results. In some aspects, the vector search may be performed locally by a VSS in host system 200. In some aspects, a vector search may be performed by a remote VSS. For example, search retriever module 220 may send the search index, the search retriever object, one or more search queries, and/or particular pieces of the metadata of the search retriever object to a VSS. The VSS may then execute the vector search and obtain search results. In aspects, the vector search may be performed by a VSS that operates on the search index according to parameters set forth by the search retriever object. In aspects, the search retrieval system may send the search index, search retriever object, search queries, and/or metadata to the VSS. The VSS may perform the vector search and return search results to the search retrieval system.

In step 340, the search retrieval system may obtain the search results created by performing the vector search. In aspects, the search retrieval system generates the search results by performing the vector search. In some aspects, the search retrieval system receives search results generated by a VSS. The search retrieval system may, in some aspects, store the search results as part of the search retriever object or as a separate data object that is associated with the search retriever object.

At step 350, the search retrieval system may retrieve the search results. In some aspects, the prompt generator module may receive the search results directly from the search retriever module after the search retriever module conducts the VSS. In some aspects, the prompt generator module may retrieve the search results from a designated storage space based on instructions from the search retriever module.

At step 355, the retrieved search results may be resolved by the model according to the prompt, and the model may generate a response to the prompt. Then, the model may generate a response to the prompt at step 360 using the retrieved and resolved search results.

At step 390, the prompt generator module may use the response to the prompt to provide a reply to the prompt request. The prompt generator module may send the reply to the user device 110a, 110b, 110c.

It will be understood that the order of the above steps are merely exemplary, and the steps can be rearranged in any appropriate manner, and that the method can be modified consistent with the present disclosure. Additionally, more or fewer steps may be included in the exemplary method consistent with the disclosure.

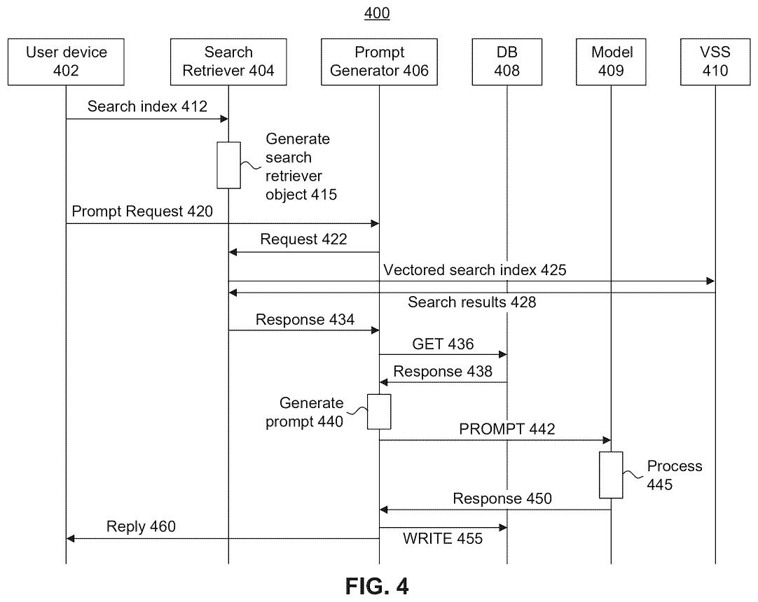

FIG. 4 illustrates a process flow diagram of an exemplary search retrieval process 400 according to aspects of the present disclosure. As shown in FIG. 4, the process occurs between a user device 402, a search retriever module 404, a prompt generator module 406, one or more databases 408, a model 409, and a VSS 410. In aspects, these elements represent exemplary aspects of user device 110, search retriever module 135/220, prompt generator module 136/230, database(s) 170, model 180, and VSS 190, respectively.

Process 400 may begin, according to aspects, with search retriever module 404 receiving a search index from user device 402 in step 412. As discussed above, the search index may be retrieved by the user or may be built by the user from a data repository.

At step 415, search retriever module 404 may generate a search retriever object based on the search index. According to aspects, the search retriever object may include metadata specifying one or more details of a search operation to be performed on the search index.

Process 400 may continue at step 420 when user device 402 sends a prompt request to prompt generator module 406. The prompt request may include a request to use a search index along with one or more search queries provided by the user. Prompt generator module 406 may begin translating the prompt request into a prompt for model 409. In aspects, prompt generator module 406 may request one or more resources. For example, at step 422, prompt generator module 406 may request search results from search retriever module 404. In response to this request, search retriever module 404 may perform the vector search operation on the search index. In aspects, search retriever module 404 may send the search index, the search retriever object, one or more search queries, and/or metadata to VSS 410 at step 425. VSS 410 may respond by sending search results to search retriever module 404 at step 428. In aspects, steps 425 and 428 may be performed locally by a VSS within search retriever module 404 or by a VSS that is external to search retriever module 404. At step 434, search retriever module 404 may respond to the request from prompt generator module 406 by providing the requested search results to the prompt generator module 406. In aspects, if the prompt request includes references to additional data from other data sets, prompt generator module 406 may at step 436 GET (retrieve) the relevant data set(s) from database(s) 408. For external data references, such as publicly available information, the retrieval may require other operations, such as an Internet search. The database(s) 408 then respond(s) in step 438 to prompt generator module 406 with the requested information.

At step 440, prompt generator module 406 may generate a prompt using the prompt request and any retrieved search results and/or data from other data sets. As discussed above, the prompt may be a set of instructions indicating how the model should resolve the search results and/or data sets.

At step 442, prompt generator module 406 may prompt model 409 by initiating the model using the generated prompt. At step 445, model 409 processes the received prompt, and then transmits a response to prompt generator module 406 in step 450. In aspects, the response may include one or more of an image, video, audio, or digital document, including spreadsheet, text file, multimedia file, etc.

Upon receipt of the response from model 409, prompt generator module 406 performs any necessary WRITES to the database(s) 408 at step 455, and then generates a reply output to the user device 402 in step 460.

It will be understood that the order of the above process steps are merely exemplary, and the steps can be rearranged in any appropriate manner, and that the process can be modified consistent with the present disclosure. Additionally, more or fewer steps may be included in the exemplary method consistent with the disclosure.

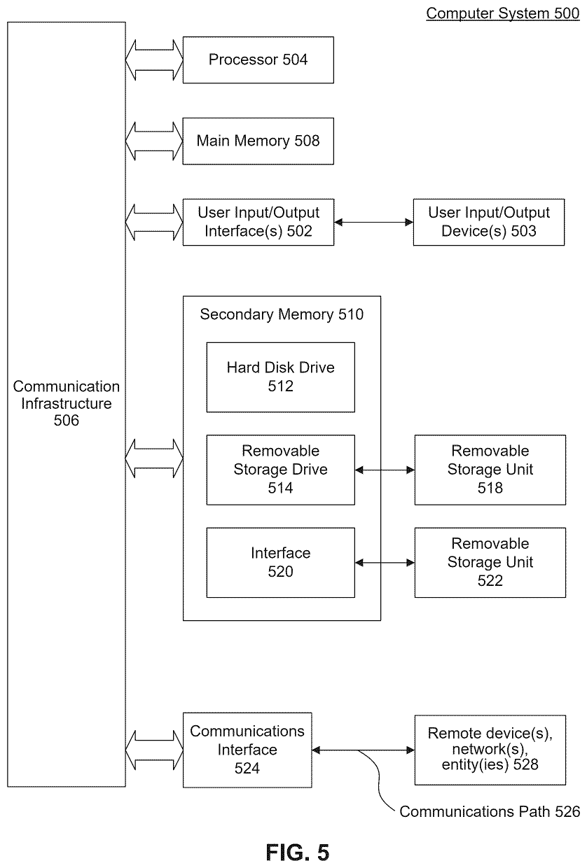

Various aspects may be implemented, for example, using one or more well-known computer systems, such as computer system 500 shown in FIG. 5. One or more computer systems 500 may be used, for example, to implement any of the aspects discussed herein, as well as combinations and sub-combinations thereof, including but not limited to the search retrieval system 200, search retriever module 220, prompt generator module 230, and/or model 180.

Computer system 500 may include one or more processors (also called central processing units, or CPUs), such as a processor 504. Processor 504 may be connected to a communication infrastructure or bus 506.

Computer system 500 may also include customer input/output device(s) 503, such as monitors, keyboards, pointing devices, etc., which may communicate with communication infrastructure 506 through customer input/output interface(s) 502.

One or more of processors 504 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random-access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/ any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings included in this disclosure, it will be apparent to persons skilled in the relevant art(s) how to make and use aspects of this disclosure using data processing devices, computer systems and/or computer architectures other than that shown in FIG. 5. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A method comprising:
generating, by one or more computing devices, a search retriever object based on a search index comprising unstructured data, the search retriever object including metadata specifying one or more details of a vector search operation to be performed on the search index;
obtaining, by the one or more computing devices, search results by performing a vector search on the search index based on the one or more details of the vector search operation provided by the search retriever object and a search query; and
providing, by the one or more computing devices, the search results to a prompt generator configured to use a model to generate a reply to a prompt request requiring the search results.

2. The method of claim 1, further comprising building the search index by creating a data object.

3. The method of claim 2, wherein the creating the data object comprises creating one or more data representations from a data repository, and
wherein the data repository comprises the unstructured data.

4. The method of claim 2, wherein the building the search index further comprises:
chunking the data object into a plurality of data chunks; and
vectorizing the data object by performing one or more mathematical operations on the plurality of data chunks to obtain vectored data chunks.

5. The method of claim 4, wherein the obtaining the search results comprises sending the vectored data chunks to a vector search service.

6. The method of claim 1, wherein the obtaining the search results comprises sending the search index to a vector search service.

7. The method of claim 6, wherein the obtaining the search results further comprises receiving the search results from the vector search service based on the search query.

8. The method of claim 1, wherein, in response to receiving the prompt request, the prompt generator is further configured to:
determine whether the search results are required to generate the reply to the prompt request; and
in response to determining that the search results are required to generate the reply to the prompt request, send a search results request to the search retriever requesting the search results.

9. The method of claim 1, wherein, in response to receiving the prompt request, the prompt generator is further configured to:
determine whether any additional data sets are required to generate the reply to the prompt request; and
in response to determining that at least one additional data set is required to generate the reply to the query, send one or more requests for the at least one additional data set to one or more databases requesting the at least one additional data set.

10. A system comprising:
a memory configured to store operations; and
one or more processors configured to perform the operations, the operations comprising:
generating a search retriever object based on a search index comprising unstructured data, the search retriever object including metadata specifying one or more details of a vector search operation to be performed on the search index,
obtaining search results by performing a vector search on the search index based on the one or more details of the vector search operation provided by the search retriever object and a search query, and
providing the search results to a prompt generator configured to use a model to generate a reply to a prompt request requiring the search results.

11. The system of claim 10, wherein the search index comprises one or more vectored data chunks formed by chunking a data object and vectorizing the chunked data object.

12. The system of claim 10, wherein the search retriever module stores a representation of the search results that can be used directly by the model.

13. The system of claim 10, wherein the search retriever object comprises a metadata object.

14. The system of claim 13, wherein the search retriever object is a retrieval augmented generation (RAG) retriever object.

15. The system of claim 10, wherein the model is a Machine Learning (ML) model or a large language model (LLM).

16. The system of claim 10, wherein the prompt generator is configured to determine if generating a reply to the prompt request requires resolving the search results.

17. The system of claim 10, wherein the prompt generator is configured to receive the prompt request and generate a set of instructions that indicate how the model should resolve the search results and one or more data sets.

18. A non-transitory computer-readable storage device having instructions stored thereon, execution of which, by one or more processing devices, causes the one or more processing devices to perform operations comprising:
generating a search retriever object based on a search index comprising unstructured data, the search retriever object including metadata specifying one or more details of a vector search operation to be performed on the search index;
obtaining search results by performing a vector search on the search index based on the one or more details of the vector search operation provided by the search retriever object and a search query; and
providing the search results to a prompt generator configured to generate a reply to a prompt request requiring the search results.

19. The non-transitory computer-readable storage device of claim 18, wherein the one or more processors further perform operations comprising:
generating a prompt for the model based on the prompt request by requesting the search results and one or more data sets;
sending the prompt to the model; and
in response to receiving a response from the model based on the prompt, generating a reply to the prompt request.

20. The non-transitory computer-readable storage device of claim 18, wherein the one or more processors further perform operations comprising:
sending the search index to a vector search service; and
receiving the search results from a vector search service.
